(19) United States
(12) Patent Application Publication
(10) Pub. No.: US 2011/0080941 A1
(43) Pub. Date: Apr. 7, 2011

(54) INFORMATION PROCESSING APPARATUS AND METHOD

(76) Inventors: Junichi OGIKUBO, Kanagawa (JP); Yasuhiro Ichinaka, Kanagawa (JP); Shigeru Ohwada, Kanagawa (JP)

(21) Appl. No.: 12/890,006

(22) Filed: Sep. 24, 2010

(30) Foreign Application Priority Data
Oct. 2, 2009 (JP) P2009-230943

(51) Int. Cl. H04N 7/26

(52) U.S. Cl. 375/240.01; 375/E07.026

(57) ABSTRACT

An information processing apparatus includes: on the basis of management information of a transcoding system of transcoding processing transcoding a format of a clip, an image generation mechanism generating a family tree being an image representing the clip by a node and representing a relationship between the clips on the transcoding processing by a link; and a display control mechanism displaying the family tree generated by the image generation mechanism on a display screen.

### BACKGROUND OF THE INVENTION

1. Field of the Invention

The present invention relates to information processing apparatuses and methods. In particular, the present invention relates to an information processing apparatus and method allowing a user to easily obtain a feature of a clip generated by format transcoding.

2. Description of the Related Art

In recent years, methods for providing and delivering contents including video or audio have become diversified, and the standards of the contents have been diversified accordingly.

Content formats are individually standardized in accordance with various uses, for example, distribution in a state of being recorded on a recording medium, such as a DVD, a CD, etc., delivery through a network, such as the Internet, etc., transfer to a mobile electronic device, digital terrestrial television broadcasting, satellite broadcasting, or, showing at a movie theater, etc.

With such diversification of contents, it has become necessary to perform transcoding (conversion) into various formats at content creation sites, and thus systems for performing format transcoding of multimedia contents are being developed (for example, refer to Japanese Unexamined Patent Application Publication (Translation of PCT Application) No. 2003-527005 and Japanese Unexamined Patent Application Publication Nos. 2002-44622 and 2002-77855).

### SUMMARY OF THE INVENTION

However, in a related-art system, information which describes features of individual files, that is to say, information describing which file is created from conversion of which file, has not been created. Accordingly, in order to search for a desired file, it is necessary for a user to check formats and images of individual files by manual work, and to do complicated work.

In recent years, requests for transcoding (conversion) of multimedia-content formats at such content creation sites have become large day by day, and transcoding (conversion) into more diversified formats are carried out more frequently.

Thereby, format conversion systems have become complicated, for example, not only new transcoding processing, but also redoing transcoding (re-transcoding) has been performed frequently, and thus the occasions of transcoding processing are increasing steadily.

In order to select a transcoding source file suitably, and to perform suitable transcoding processing at the time of such transcoding processing, it is necessary to clarify features of individual files. However, in a related-art system, information clarifying such a feature is not created, and thus it is necessary for the user to check individual files one by one. Thereby, complicated work might be necessary for the user.

The present invention has been proposed in view of such circumstances. It is desirable to allow the user to easily grasp a feature of a clip generated by format transcoding.

According to an embodiment of the present invention, there is provided an information processing apparatus including: on the basis of management information of a transcoding system of transcoding processing transcoding a format of a clip, an image generation means for generating a family tree being an image representing the clip by a node and representing a relationship between the clips on the transcoding processing by a link; and a display control means for displaying the family tree generated by the image generation means on a display screen.

In the above-described embodiment, the image generation means may generate the family tree having a tree structure, representing the node by a predetermined figure, representing the link by a line or an arrow, and representing a generation of the transcoding of the clip by a position of the node in a right-and-left direction, and the display control means may display the family tree having the tree structure, generated by the image generation means.

The image generation means may generate the family tree having the tree structure such that whether there is a file of each clip or not is indicated by a method of displaying the node.

The image generation means may generate the family tree having the tree structure such that an image size of each clip is indicated by a size of the node.

The image generation means may generate the tree-structured family tree such that a bit rate or a frame rate of each clip is indicated by color or a density of the node.

The image generation means may copy a configuration of the family tree having the tree structure under a desired clip to another clip in accordance with predetermined operation input by a user.

The image generation means may generate the family tree having a genealogical structure, representing the node by a predetermined figure, representing the link by a line or an arrow, and representing a generation of the transcoding of the clip by a position of the node in an up-and-down direction; and the display control means may display the family tree having the genealogical structure, generated by the image generation means.

The image generation means may generate the family tree having the genealogical structure such that whether there is a file of each clip or not is indicated by a method of displaying the node.

The image generation means may generate the family tree having the genealogical structure such that an image size of each clip is indicated by a size of the node.

The image generation means may generate the family tree having the genealogical structure such that a bit rate or a frame rate of each clip is indicated by color or density of the node.

The image generation means may copy the family tree having the genealogical structure under a desired clip to another clip in accordance with predetermined operation input by a user.

The image generation means may generate the graphical family tree representing the node by a predetermined figure, representing the link by a line or an arrow, and representing a feature of the clip by a position of the node on the graph; and the display control means may display the graphical family tree generated by the image generation means.

The image generation means may assign different parameters with each other to individual axes of the graph.

The graph may be a two-dimensional graph.

The graph may be a three-dimensional graph.

The information processing apparatus may further include an instruction accepting means for accepting a user's instruction input on the basis of the family tree displayed on the display screen.

According to another embodiment of the present invention, there is provided a method of processing information, including the steps of: on the basis of management information of a transcoding system of transcoding processing transcoding a format of a clip, generating a family tree being an image representing the clip by a node and representing a relationship between the clips on the transcoding processing by a link; and displaying the generated family tree on a display screen.

In an embodiment of the present invention, on the basis of management information of a transcoding system of transcoding processing transcoding a format of a clip, a family tree, in which a clip is represented by a node and a relationship between the clips on the transcoding processing is represented by a link, is generated, and the generated family tree is displayed on a display screen.

By the present invention, it is possible to transcode a content format. In particular, it is possible for the user to easily grasp the feature of a clip generated by the format transcoding.

### BRIEF DESCRIPTION OF THE DRAWINGS

FIG. 1 is a block diagram illustrating an example of a main configuration of a transcoding system to which the present invention is applied;

FIG. 2 is a diagram explaining a state of multi-format transcoding;

FIG. 3 is a diagram illustrating an example of a format-transcoding system;

FIG. 4 is a block diagram illustrating an example of a main configuration of the remote client in FIG. 1;

FIG. 5 is a block diagram illustrating an example of a main configuration of the multi-format transcoder in FIG. 1;

FIG. 6 is a functional block diagram illustrating functions held by individual devices;

FIG. 7 is a diagram illustrating an example of main functional blocks held by a remote client;

FIG. 8 is a diagram explaining an example of GUI display of a remote client;

FIG. 9 is a diagram explaining a display example of a family tree;

FIG. 10 is a diagram explaining an example of a user's instruction given using GUI;

FIG. 11 is a flowchart explaining an example of client processing;

FIG. 12 is a flowchart explaining the example of the client processing following FIG. 11;

FIG. 13 is a diagram explaining another display example of a family tree;

FIG. 14 is a diagram explaining still another display example of a family tree;

FIG. 15 is a diagram explaining a state of specifying a clip;

FIG. 16 is a diagram explaining still another display example of a family tree;

FIG. 17 is a diagram explaining still another display example of a family tree;

FIG. 18 is a diagram explaining still another display example of a family tree;

FIG. 19 is a diagram illustrating an example of multi-task management; and

FIG. 20 is a diagram illustrating an example of a state of multi-task parallel execution.

### DESCRIPTION OF THE PREFERRED EMBODIMENTS

In the following, a detailed description will be given of a mode for carrying out the invention (hereinafter referred to as an embodiment). In this regard, the description will be given in the following order.

### 1. First Embodiment

### Transcoding System

### 1. First Embodiment

### Configuration of Transcoding System

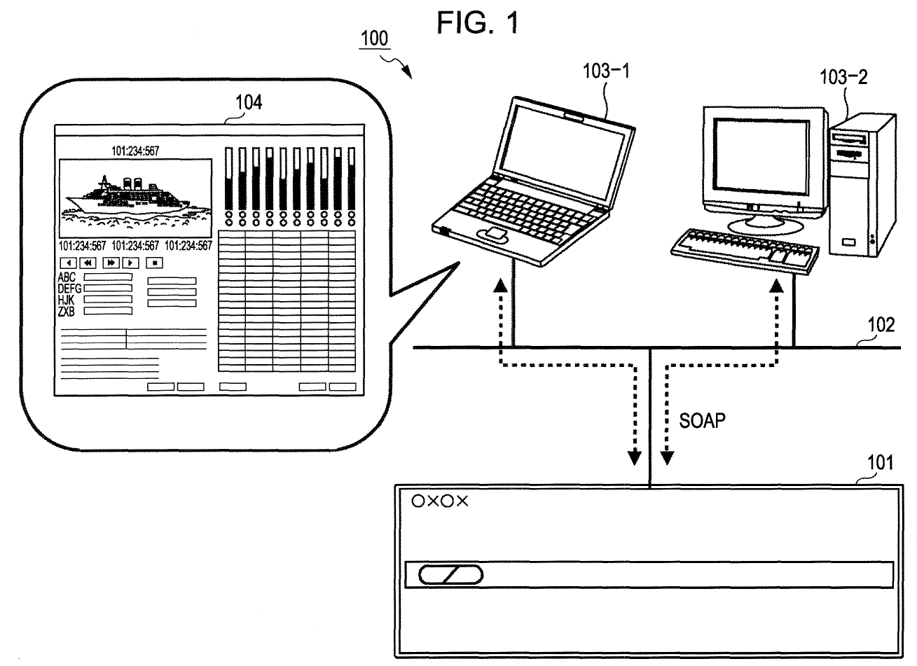

FIG. 1 illustrates a configuration of a transcoding system according to an embodiment of the present invention.

Referring to FIG. 1, a transcoding system 100 is an information processing system which transcodes (converts) a format of a multimedia content capable of including video and audio data.

As shown in FIG. 1, the transcoding system 100 has a multi-format transcoder 101, a remote client 103-1, and a remote client 103-2, which are connected through a network (Network) 102.

The multi-format transcoder 101 is a processing apparatus which transcodes (converts) a format of a content. The multi-format transcoder 101 can process a multimedia content including video or audio data.

Even if each material data, such as video, audio, etc., for example, included in the content is contained in a corresponding one of files, the multi-format transcoder 101 manages and processes the files as one material. In this manner, a set of material data, meta-data, etc., which is regarded as one material by the multi-format transcoder 101 is referred to as a clip.

The clip may include any data. In the following, for the convenience of explanation, it is assumed that the clip includes video data, audio data, proxy data (low-resolution data), which is low-resolution video produced from the video data, and meta-data on the content and each data. Of course, a clip does not necessarily include all the data, and also may include the other data.

In this regard, the meta-data includes information on a content and each data. For example, a content name, a scene and a take number, time codes of an IN point and an OUT point, a duration, creation date, update date, a supplementary memo at shooting time, such as a place and weather, etc., a comment, etc. Of course, the meta-data may include any information other than this, and also may not include these pieces of information.

Clips are standardized in various ways for the uses thereof, etc., and there are various formats. Depending on the format, each data (each file) included in a clip may have a different format, and information included in each data may be different. The multi-format transcoder 101 performs processing which transcodes (transcoding) a format of such a clip into another format.

The multi-format transcoder 101 is controlled by a remote client 103-1 or a remote client 103-2 through a network 102 exemplified by the Internet, a LAN (Local Area Network), etc.

The remote client 103-1 and the remote client 103-2 communicate with the multi-format transcoder 101 using SOAP (Simple Object Access Protocol), and control the operation of the multi-format transcoder 101. Of course, a protocol other than SOAP may be used.

When it is not necessary to distinguish the remote client 103-1 and the remote client 103-2 with each other for explanation, either of the clients is simply referred to as a remote client 103. Any number of the remote clients 103 may be used in the transcoding system 100. Also, the remote client 103 may be any electronic device that can communicate with the multi-format transcoder 101 through the network 102, and can control the multi-format transcoder 101. For example, the remote client 103 may be a so-called mobile device that can be moved, such as a notebook-sized personal computer or a mobile telephone, or may be a stationary electronic device, such as a desktop personal computer and a hard disk recorder.

A GUI (Graphical User Interface) 104 for accepting an operation for controlling the multi-format transcoder 101 is displayed on a monitor of the remote client 103. The user inputs an operation on the GUI 104 into the remote client 103. The remote client 103 supplies the input user instruction to the multi-format transcoder 101 through the network 102, thereby controlling the operation of the multi-format transcoder 101.

Of course, the network 102 may have any configuration as far as the network serves a communication medium between the multi-format transcoder 101 and the remote client. For example, the network may be a wired communication network, or a wireless communication network, or may include both of them. Also, the network 102 may be configured by a plurality of networks.

Further, the transcoding system 100 may have a plurality of multi-format transcoders 101.

Overview of Transcoding

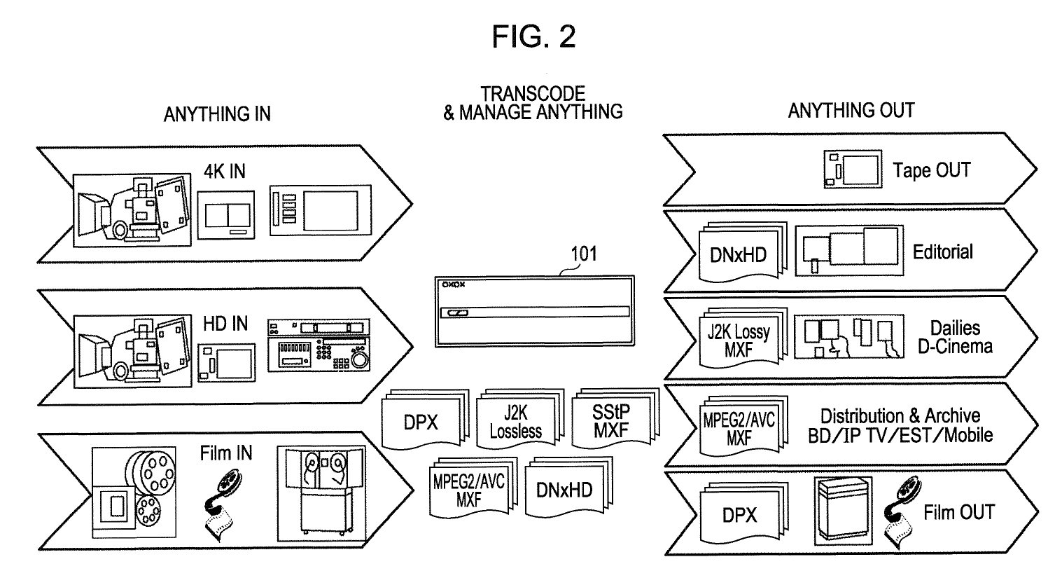

Next, a description will be given of an overview of transcoding by the multi-format transcoder 101. FIG. 2 is a diagram explaining a state of multi-format transcoding.

The multi-format transcoder 101 may have an encoder and a decoder to any standards, and can perform transcoding (transcoding processing) between any formats.

For example, as shown in FIG. 2, the multi-format transcoder 101 can perform transcoding processing of the formats of MXF (material exchange format), which is a business-use video-file format using DPX (Digital Picture Exchange), a lossless JPEG (Joint Photographic Experts Group) 2000, MPEG (Moving Picture Experts Group) 2, AVC (Advanced Video Coding), etc., or DNxHD, etc.

In this regard, the multi-format transcoder 101 transcodes (converts) a clip format. That is to say, the transcoding includes not only re-encoding of material data, such as an image, audio, etc., for example, a change in an image size, an aspect ratio, of a frame rate, etc., or printing of a time code, a title, etc., but also includes all transcoding processing on format transcoding, for example, update of meta-data contents, etc.

The multi-format transcoder 101 stores and manages a group of files constituting a content as a clip, and transcodes the stored clip. To put it another way, the multi-format transcoder 101 specifies the files stored as a clip to be a target of transcoding processing.

However, the multi-format transcoder 101 has a function of changing a content of any type into digital data, and storing as a clip (ingest function). Accordingly, an input content may be of any type (Anything In).

For example, as shown in FIG. 2, a content to be input may be a multimedia content including a so-called 4K video having 4096×2160 dots for use in a digital cinema, etc., or may be a multimedia content including an HD (High-Definition) image having 1920×1080 dots. These pieces of data may be transmitted to the multi-format transcoder 101 through the network 102, or may be supplied to the multi-format transcoder 101 in a state of being recorded on a recording medium, such as an optical disc, a flash memory, etc. Also, the data may not be digital data as in the case of a film video.

In the same manner, the multi-format transcoder 101 has a function of transcoding digital data into a content of any type. Accordingly, a content to be output is of any type (Anything Out).

For example, the multi-format transcoder 101 can output a trans coded clip as a VTR (Tape OUT), or edit data, or a content of digital cinema, or a content having a distribution standard or a storage standard, or film video.

The multi-format transcoder 101 not only transcodes any format into any other format as described above, but also manages information on the transcoding (transcoding management information) (Transcode & Manage Anything).

The multi-format transcoder 101 makes and manages a database including, for example, transcoding contents (transcoding parameters) and information (meta-data, etc.) on each clip (or file) before and after transcoding as transcoding management information. Also, the multi-format transcoder 101 makes and manages a database including a transcoding genealogy (a family tree), which is information indicating the transcoding state (system), that is to say, information indicating which clip (file) is created from which clip (file), as transcoding management information.

Transcoding System

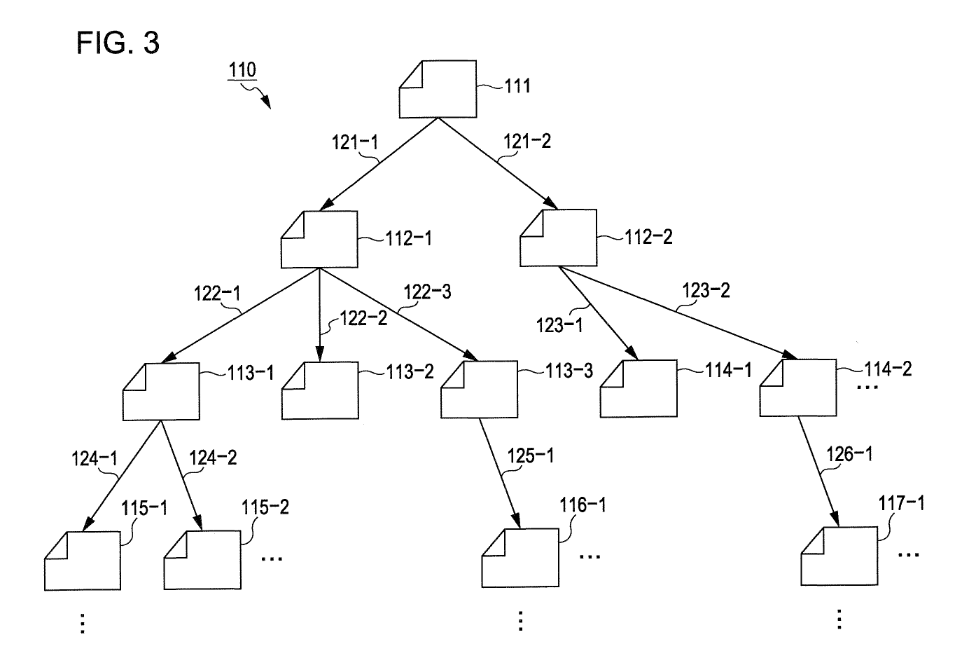

Next, a more detailed description will be given of the transcoding system. FIG. 3 is a diagram illustrating an example of a format-transcoding system.

In FIG. 3, a transcoding system 110 shows a transcoding system in which a clip 111 is specified as an original (originator). As shown in FIG. 3, in the transcoding system 110, the clip 111 is transcoded to generate a clip 112-1 as an arrow 121-1. In the same manner, the clip 111 is transcoded to generate a clip 112-2 as an arrow 121-2.

In the following, in the same manner, the clip 112-1 is transcoded (an arrow 122-1 to an arrow 122-3) to generate a clip 113-1 to a clip 113-3, respectively. The clip 112-2 is transcoded (an arrow 123-1 and an arrow 123-2) to generate a clip 114-1 and a clip 114-2, respectively.

Further, in the same manner, the clip 113-1 is transcoded (an arrow 124-1 and an arrow 124-2) to generate a clip 115-1 and a clip 115-2. The clip 113-3 is transcoded (an arrow 125-1) to generate a clip 116-1, and the clip 114-2 is transcoded (an arrow 126-1) to generate a clip 117-1.

In this manner, one clip can be transcoded into a plurality of formats. Also, the transcoded clip can be further transcoded. In such transcoding, as shown in FIG. 3, one transcoding system 110 having one clip as an original (originator) is formed.

In recent years, content formats have become more diversified. For example, it is thought that one content is shown at a movie theater, is marketed as a DVD (Digital Versatile Disc) and a BD (Blu-ray Disc), is distributed through the Internet, is transferred to a mobile device, such as a mobile telephone, an electronic game machine, etc., and is broadcast as a television signal.

In recent years, in creating a content, it has become necessary that a content to be created is corresponding to these various formats. Thus, format transcoding has been carried out more frequently. Also, in the case of creating a content, it often becomes necessary to perform the other format transcoding for use in other than a final stage, for example trial production, management, etc. Further, it has often become necessary to perform transcoding into the other formats, and thus the occasions of transcoding increase moreover. Accordingly, the transcoding system 110 as shown in FIG. 3 has become more complicated.

Incidentally, when transcoding is carried out, information before transcoding is basically reduced (deteriorated). However, new piece of information is sometimes added. Accordingly, when new transcoding is carried out in order to obtain an intended format, for the selection of the transcoding-source clip, it is desirable to select a best-suited node (clip) in the individual nodes of the transcoding system 110 in order to allow obtaining necessary information, and not to increase processing load unnecessarily.

However, if the transcoding system 110 becomes complicated, it becomes difficult for a user to manage all of the clips (for example, storing and manually recording). If the user has not obtained the transcoding system 110, it is necessary for the user to individually check each file format of each clip, etc., and to select a best-suited clip for a transcoding-source clip. Thus, troublesome work is necessary for the user.

The multi-format transcoder 101 manages the transcoding system 110 as a family tree (genealogy), and thus allows the user to easily grasp a relationship between the clips and each clip format, etc., on the basis of the information. That is to say, it is possible for the user to search for a best-suited clip as the above-described transcoding source. To put it another way, it is possible for the user to easily search for any clip pertaining to a transcoding system to which a certain clip pertains (or individual files pertaining to the clip).

Incidentally, it is thought that a file (actual data) of each clip generated by transcoding is sometimes deleted. And further it is thought that a file deleted in this manner is sometimes going to be reused (re-transcoding). In such a case, the user is allowed to easily and correctly identify a clip to be a transcoding source of the deleted file by the information on the transcoding managed by the multi-format transcoder 101. Further, the user is allowed to easily grasp the contents of the transcoding. That is to say, the multi-format transcoder 101 can easily restore the clip whose file has been deleted.

In this regard, if all the files of all the clips that can be a transcoding source have been deleted, etc., it is thought that the files of an intended clip are difficult to be restored. By the information on the transcoding managed by the multi-format transcoder 101, the user is allowed to easily grasp whether a desired file can be restored or not in this manner.

As described above, by managing information on transcoding, the multi-format transcoder 101 can easily restore a desired clip, and thus it is not necessary for the user to store all the files generated by the transcoding. That is to say, it is possible for the user to reduce cost for file storage by the multi-format transcoder 101. In recent years, the amount of content data increases steadily, and thus it is very advantageous to allow deletion of unnecessary files, such as inactive files, etc.

By displaying a GUI image on a monitor, etc., the remote client 103 accepts a user operation on the multi-format transcoder 101. That is to say, the remote client 103 displays a family tree (FT), etc., indicating the above-described transcoding system (features of the individual clips included therein), etc., to present the information to the user.

As described above, transcoding systems have steadily become complicated, and thus if the way of presentation of a family tree (FT) indicating a transcoding system is not suitable, it becomes difficult for the user to understand the system. Accordingly, the operationality of the multi-format transcoder 101 might deteriorate.

Thus, the remote client 103 displays a family tree (FT) in a more suitable way of presentation such that the user is allowed to easily understand the structure of a transcoding system and features of clips. Thereby, the operationality of the multi-format transcoder 101 is improved, and thus it becomes possible for the user to more easily control the transcoding.

Device Configuration

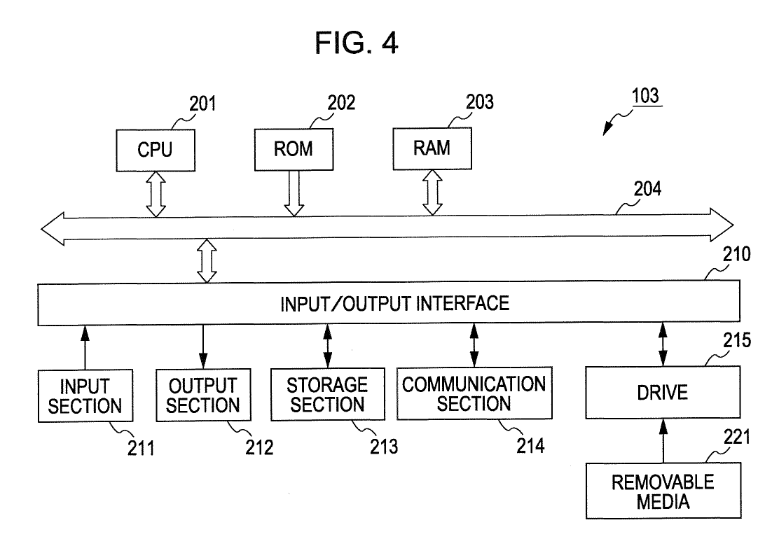

Next, a description will be given of a configuration of individual devices constituting the transcoding system 100. FIG. 4 is a block diagram illustrating an example of a main hardware configuration of the remote client in FIG. 1.

Referring to FIG. 4, a CPU (Central Processing Unit) 201 of the remote client 103 performs various kinds of processing in accordance with programs stored in a ROM (Read Only Memory) 202 or programs loaded from a storage section 213 to a RAM (Random Access Memory) 203. Also, the RAM 203 suitably stores data, etc., necessary for the CPU 201 to execute the various kinds of processing.

The CPU 201, the ROM 202, and the RAM 203 are mutually connected through a bus 204. The bus 204 is also connected to an input/output interface 210.

An input section 211 including a keyboard, a mouse, etc., an output section 212 including a display including a CRT (Cathode Ray Tube), a LCD (Liquid Crystal Display), etc., and a speaker, etc., a storage section 213 including a hard disk, an SSD (Solid State Drive), etc., a communication section 214 including a modem, a wired LAN (Local Area Network) interface, a wireless LAN interface, etc., are connected to the input/output interface 210. The communication section 214 performs communication processing through a network 102 including, for example, the Internet, etc.

A drive 215 is connected to the input/output interface 210 as necessary. A removable media 221, such as a magnetic disk, an optical disc, a magneto-optical disc, or a semiconductor memory, etc., are suitably loaded to the drive 215, and computer programs and data read therefrom are installed into the storage section 213 as necessary.

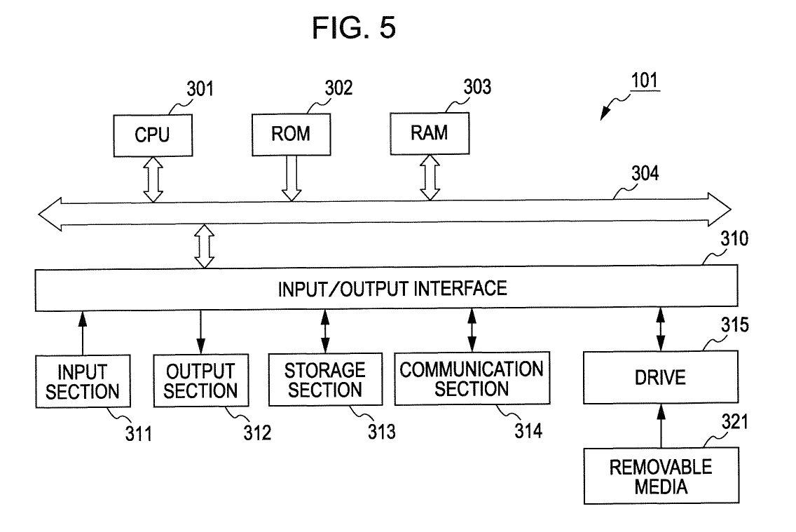

FIG. 5 is a block diagram illustrating an example of a main hardware configuration of the multi-format transcoder in FIG. 1.

As shown in FIG. 5, the multi-format transcoder 101 has basically the same configuration as that of the remote client 103 in FIG. 4. That is to say, the multi-format transcoder 101 has a CPU 301 corresponding to the CPU 201, a ROM 302 corresponding to the ROM 202, a RAM 303 corresponding to the RAM 203, and a bus 304 corresponding to the bus 204. Also, the multi-format transcoder 101 has an input/output interface 310 corresponding to the input/output interface 210, an input section 311 corresponding to the input section 211, an output section 312 corresponding to the output section 212, a storage section 313 corresponding to the storage section 213, a communication section 314 corresponding to the communication section 214, and a drive 315 corresponding to the drive 215. A removable media 321 corresponding to the removable media 221 is attached to the drive 315.

Of course, the remote client 103 and the multi-format transcoder 101 may have respective configurations other than those described above.

Functional Blocks of Transcoding System

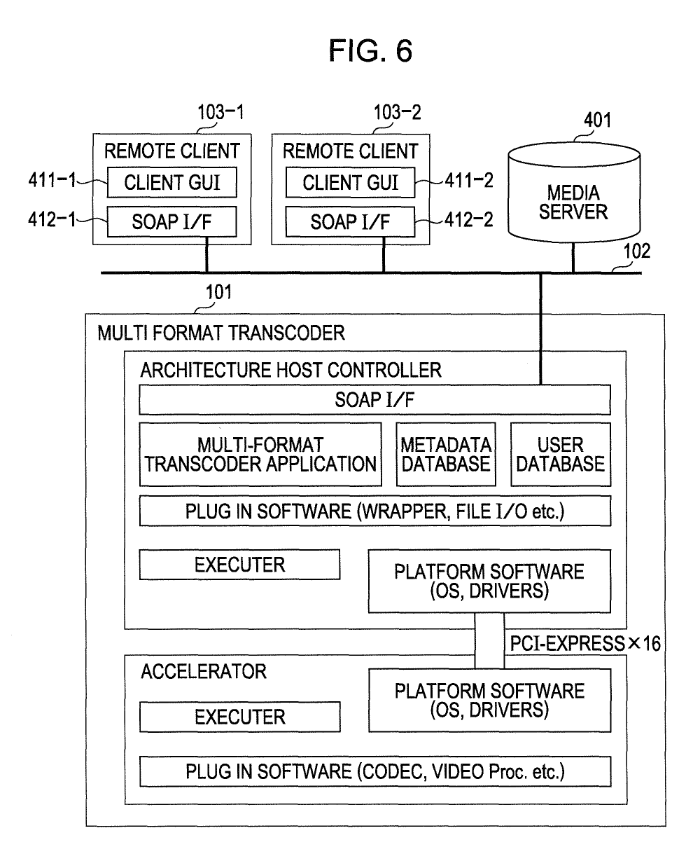

Next, a description will be given of functions of the individual devices. FIG. 6 is a functional block diagram illustrating functions held by the individual devices.

As shown in FIG. 6, the remote client 103-1 has a client GUI 411-1, which is a function of displaying a GUI for the user to control the multi-format transcoder 101, and an SOAP interface (SOAP i/f) 412-1, which is a communication function with the multi-format transcoder 101.

In the same manner, the remote client 103-2 has a client GUI 411-2 and an SOAP interface (SOAP i/f) 412-2.

In the following, when it is not necessary to distinguish the client GUI 411-1 from the client GUI 411-2 for the sake of explanation, either of the GUI is simply referred to as a client GUI 411. In the same manner, when it is not necessary to distinguish the SOAP interface (SOAP i/f) 412-1 from the SOAP interface (SOAP i/f) 412-2 for the sake of explanation, either of the interface is simply referred to as an SOAP interface (SOAP i/f) 412.

That is to say, each of the remote clients 103 has the client GUI 411 and the SOAP interface (SOAP i/f) 412.

The multi-format transcoder 101 has an architecture host controller, which controls transcoding processing, and an accelerator, which is controlled by the architecture host controller and actually performs transcoding processing.

The architecture host controller has an SOAP interface (SOAP i/f) having a function of performing communication with the remote client 103 through the network 102. Also, the architecture host controller has a multi-format transcoder application achieving various functions of the multi-format transcoder 101.

Further, the architecture host controller has a meta-data database, which manages meta-data of individual files and a user database, which manages information on the transcoding.

Also, the architecture host controller has plug-in software for a wrapper and file-input/output (File I/O), etc., which is suitably executed with the execution of an application.

Further, the architecture host controller has an execution section (executer) which executes various kinds of processing by applications, etc.

Also, the architecture host controller has platform software which includes an OS, a driver, etc.

The platform software of the architecture host controller operates in cooperation with the platform software of the accelerator through a bus, for example, a PCI Express x16, etc.

The accelerator also has an execution section (executer) executing a task specified by the architecture host controller, and plug-in software suitably executed for coding (codec) and image processing (video proc), etc., together with the execution of the task.

That is to say, the architecture host controller performs communication with the remote client 103, and generation and management, etc., of tasks on the transcoding and the other processing. The accelerator executes the tasks generated by the architecture host controller. Also, the architecture host controller performs generation and management of information on the transcoding.

In this regard, the architecture host controller and the accelerator may be achieved by CPUs that are physically different with each other. Alternatively, the architecture host controller and the accelerator may be achieved by different cores and threads that are different with each other in one CPU, or may be achieved by time sharing in one core.

In this regard, as shown in FIG. 6, it is assumed that a media server 401 which stores clip files is connected to the network 102. That is to say, the multi-format transcoder 101 stores and manages file-storage addresses, a part or all of meta-data, etc., but does not store (manage) the files themselves for the sake of cost reduction, etc. Of course, the architecture host controller may store the files therein.

Functional Blocks of Remote Client

Next, a detailed description will be given of functions held by the remote client 103, which is a user interface for controlling the multi-format transcoder 101.

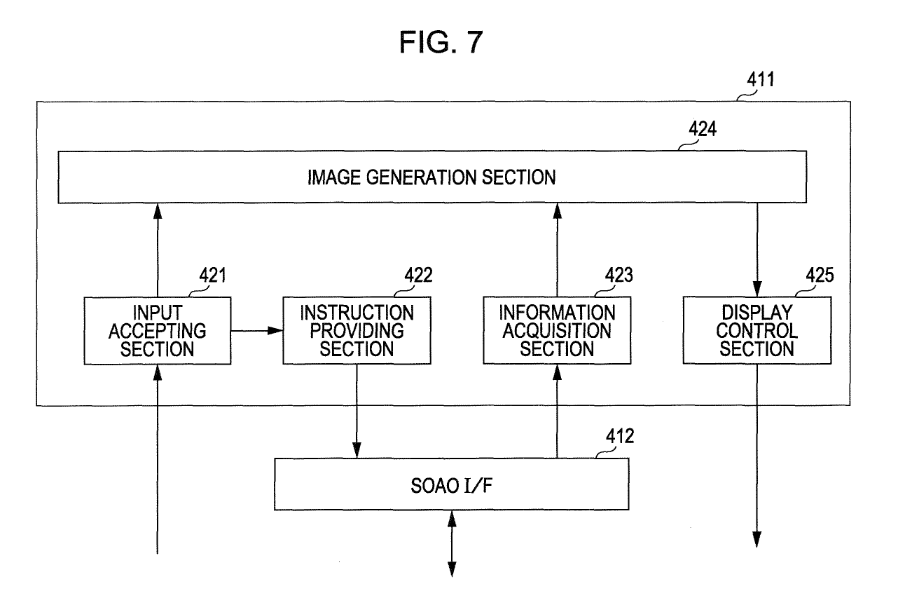

FIG. 7 is a diagram illustrating an example of main functional blocks held by the remote client. As shown in FIG. 7, the client GUI 411 of the remote client 103 has an input accepting section 421, an instruction providing section 422, an information acquisition section 423, an image generation section 424, and a display control section 425.

The input accepting section 421 controls the input section 211, etc., to accept an instruction input by the user. If the accepted user instruction is an instruction regarding display update, for example, cursor move, pressing on a GUI button, etc., the input accepting section 421 supplies the user instruction to the image generation section 424. Also, if the accepted user instruction is an instruction to the multi-format transcoder 101, for example, a command input or a shortcut-key operation, the input accepting section 421 supplies the user instruction to the instruction providing section 422.

The instruction providing section 422 supplies a user instruction supplied from the input accepting section 421 or a user instruction to the multi-format transcoder 101 obtained as a result of cursor move or a GUI-button operation, etc., to the multi-format transcoder 101 through the SOAP interface 412.

The information acquisition section 423 obtains various kinds of information supplied from the multi-format transcoder 101 and the other devices through the SOAP interface 412, and supplies the information to the image generation section 424.

The image generation section 424 generates an image on the basis of a user instruction supplied from the input accepting section 421 and various kinds of information supplied from the information acquisition section 423, and supplies the image to the display control section 425.

The display control section 425 displays the supplied image to a monitor included in the output section 212, for example.

Tree-Structured Display

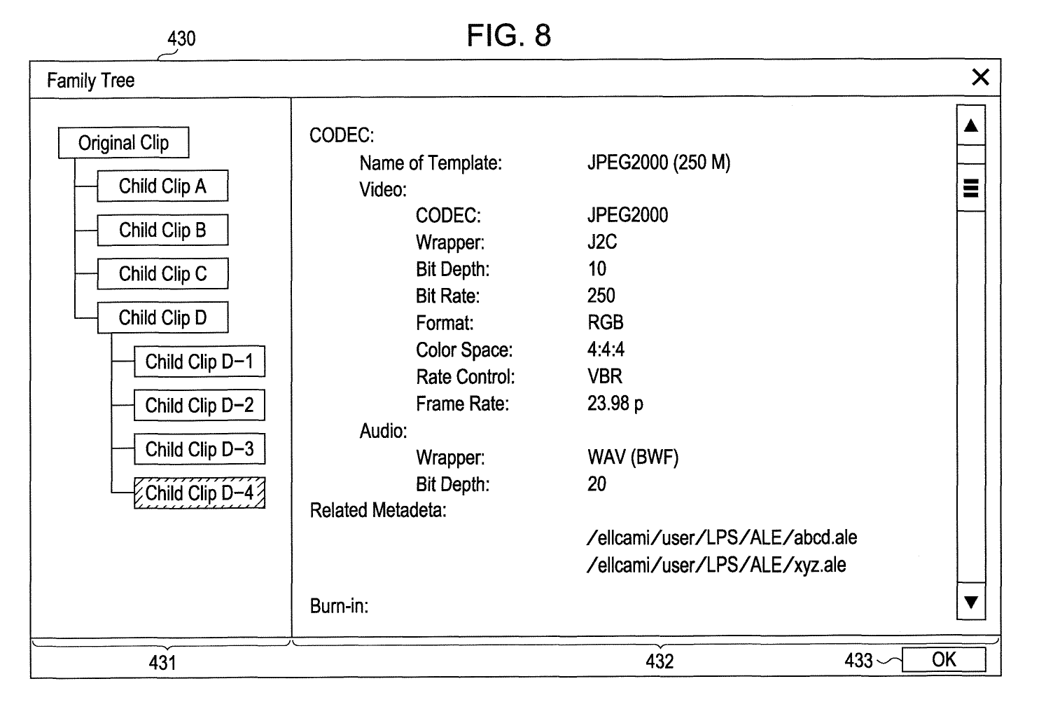

FIG. 8 is a diagram explaining an example of a GUI image displayed on a monitor of the remote client 103.

A GUI image for FT 430, shown in FIG. 8, is a GUI image displaying a family tree (FT). The area of the GUI image for FT 430 is divided into right and left areas. In the left area 431, a tree-structured family tree showing a transcoding system is displayed.

The multi-format transcoder 101 manages a transcoding system of the executed transcoding as FT information. The FT information, which is management information for managing the transcoding system includes, for example, an FTID identifying a family tree (FT) and CIDs of individual clips pertaining to the FT. The CIDs are tied to each other in order to show a relationship among clips on transcoding (transcoding system). That is to say, the FT information includes information indicating which clip is generated from which clip, or which clip is necessary in order to generate which clip, or which is an original (originator) clip, etc.

In the area 431 of the GUI image for FT 430, a family tree (FT) having an image of such FT information obtained from the multi-format transcoder 101 is displayed. The family tree is an image in which each CID (clip) included in FT information is denoted as a node by a graphic symbol, etc., relationships between CIDs in FT information (relationship with clips on transcoding) are denoted as links by lines, arrows, etc. The family tree is displayed in the area 431 of the GUI image for FT 430 in a tree structure. That is to say, the image generation section 424 generates a tree-structured family tree.

In the case of the example in FIG. 8, a family tree displayed in the GUI image for FT 430 indicates that a clip (original clip) of an original (originator) has been transcoded four times to generate four child clips (child clip A, child clip B, child clip C, and child clip D). Further, the child clip D has been transcoded four times to generate four child clips (child clip D-1, child clip D-2, child clip D-3, and child clip D-4).

In this manner, in a tree-structured display method, clips are tied to each other so that a relationship between clips before and after transcoding (parent-child relationship) is shown. Also, a transcoding generation is shown by a clip position in right and left directions. For example, “child clip A”, “child clip B”, “child clip C”, and “child clip D”, which are tied to “original clip” by a line (or arrow) and positioned on the right side of “original clip”, are the children (child clips) that are generated by transcoding the “original clip”. To put it another way, a parent clip (transcoding source clip) of the “child clip A”, the “child clip B”, the “child clip C”, and the “child clip D” becomes the “original clip”.

Also, for example, the “child clip D-1” is tied indirectly to the “original clip” through the “child clip D”, and thus is a grandchild clip of the “original clip”.

In this manner, a tree-structured family tree is shown in order to allow the user to intuitively grasp which clip is transcoded to generate which clip, that is to say, a feature of each clip. Thereby, the user is allowed to easily grasp the configuration of a transcoding system.

Also, parent-child relationships are shown, and thus if the user, for example, restores files of a deleted clip, the user is allowed to easily identify which clip ought to be transcoded (a necessary clip for restoration). Further, the position of a clip shows a generation so that the user is allowed to easily grasp a degree of deterioration by transcoding of each clip.

Also, in the right area 432 of the GUI image for FT 430, clip information of a clip specified among the tree-structured family tree is displayed. The clip information is information on a clip, and includes, for example, a clip name, an owner, a time stamp, an image size (video size), a frame rate, a coding parameter (encode param), a coding method (codec), a coding bit rate, a file path (source (parent) file path) of a file before transporting (parent file), a file path (related meta-data file path) of the meta-data of the clip, CID (clip identification information), which is identification information of the clip, FTID (family tree identification information), which is identification information of a family tree (FT) to which the clip pertains, transcoding parameters (transcoding param) used for transcoding, and a path of each file, etc.

Of course, information other than these pieces of information may be included in the clip information. For example, in the case of the example in FIG. 8, in the area 432, as the clip information, a wrapper, a bit depth, a color format name (format), a color space, and a rate control of a video, an audio wrapper, and a bit depth, etc., are displayed. That is to say, these pieces of information may be included in the clip information.

In this manner, the user is allowed to easily refer to information on a desired clip.

An OK button 433 of the GUI image for FT 430 is a GUI button which determines the selection of the currently specified clip by the user's pressing operation. That is to say, if the user presses the OK button 433, the currently-selected clip is determined to be a selected clip, and this information is applied to the other tools, etc.

Accordingly, the user is allowed to easily select a desired clip. That is to say, the remote client 103 displays the GUI image for FT 430 as described above so that the user is allowed, for example, to easily search for a desired clip related to a certain clip on transcoding, and to select the clip.

Tree-Structured Application 1

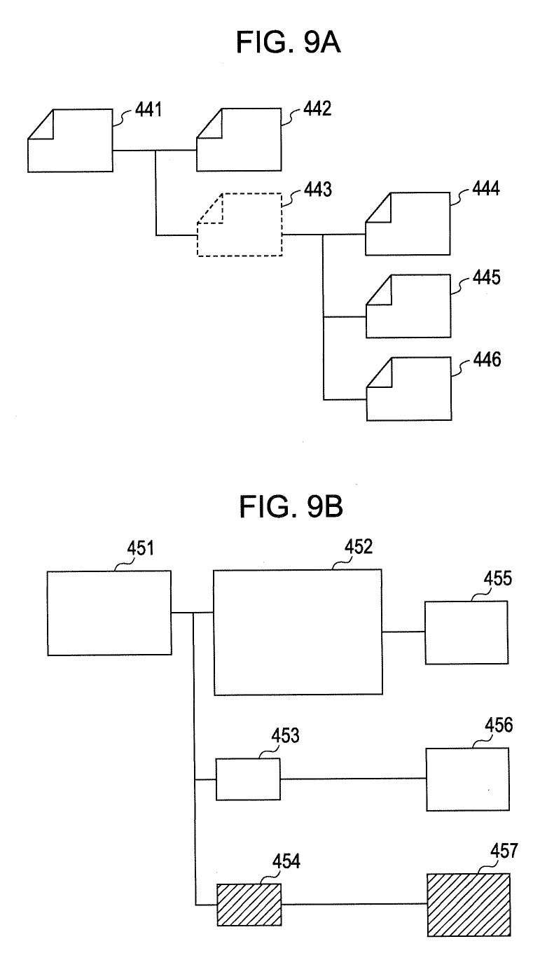

In this regard, for example, for a clip whose file has been deleted, for example, as shown in FIG. 9A, displaying the node (for example, color, a density, a shape, or a size, etc.) of a family tree may be changed. In the case of the example in FIG. 9A, a clip 443 whose file has been deleted is shown by a dotted line.

Thereby, the user is allowed to easily grasp whether there is a desired clip file or not. Also, the user is allowed to easily and correctly grasp whether a desired clip is possible to be restored or not, and if possible, which clip ought to be used for restoration, etc.

Also, an image size (resolution) of an image included in a clip may be denoted by a size of each node in a family tree (FT). For example, each rectangle of the family tree, shown in FIG. 9B, denotes a node (clip), and the size of each rectangle denotes an image size (resolution) of a corresponding clip image. In the case of the example in FIG. 9B, the image of the clip 452 having a largest rectangle has a highest resolution, and the images of the clip 453 and the clip 454 having a smallest rectangle have a lowest resolution.

Also, a quality (for example, a bit rate or a frame rate) of an image included in a clip may be denoted by color or a density, etc., of each node of a family tree (FT). For example, in the family tree shown in FIG. 9B, shaded clip 454 and clip 457 denote that the clips have lower qualities than the other clips (for example, having a lower bit rate or frame rate).

In this manner, clip contents and state are denoted by displaying each node so that the user is allowed to intuitively (easily) grasp the contents and the state of the clip. Of course, the parameters other than the above-described ones may be denoted by individual clip display.

Also, a thumbnail image of an image included in a clip may be used as each node of a family tree. In that case, the user can easily grasp the contents of a content of each clip by referring to a family tree (FT).

Tree-Structured Application 2

The user may be allowed to edit a transcoding system using a family tree (FT) displayed in the area 431 of the GUI image for FT 430.

For example, the user may be allowed to copy and move a configuration of a family tree by a predetermined operation, such as drag and drop and copy and paste.

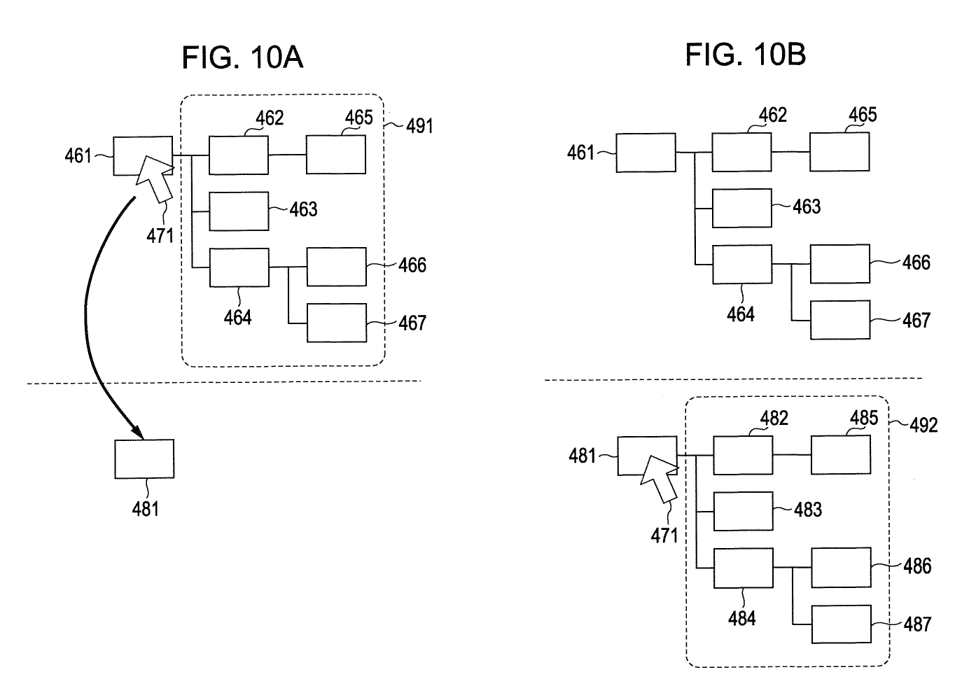

FIG. 10 illustrates an example of the operation. For example, as shown in FIG. 10A, if the user places a cursor 471 on a clip 461, and performs drag-and-drop operation on another clip 481, the configuration of a family tree 491 (clip 462 to clip 467) under the clip 461 is copied to a clip 481.

That is to say, as shown in FIG. 10B, a family tree 492 (clip 482 to clip 487) having the same configuration as that of the family tree 491 is formed under the clip 481.

At this point in time, transcoding is still in a planning stage. If the user instructs execution of transcoding from this state, the transcoding is executed as planned, and the clip 482 to the clip 487 (files thereof) are actually generated. That is to say, a transcoding system having the same configuration as the transcoding system under the clip 461 is generated under the clip 481.

For example, in creating contents, there are cases where the same transcoding is performed on any one of contents. For example, there are cases where processing for creating a content for a DVD and a content for television broadcasting from a content for a movie is specified as fixed processing, and the fixed processing is performed on any one of the movie contents.

In such a case, as described above, a configuration of a family tree (FT) is copied, and the execution of a plurality of transcoding can be specified as fixed processing so that the user is allowed to easily instruct the transcoding work.

In this regard, the above-described drag-and-drop (instruction of copying) operation may serve as an instruction to start transcoding. That is to say, at the point in time when the user performs the drag-and-drop operation on the clip 461 to the clip 481, transcoding may be started.

Of course, an instruction of copying and an instruction of starting transcoding may be specified in a different way other than the above-described ways.

Processing Flow

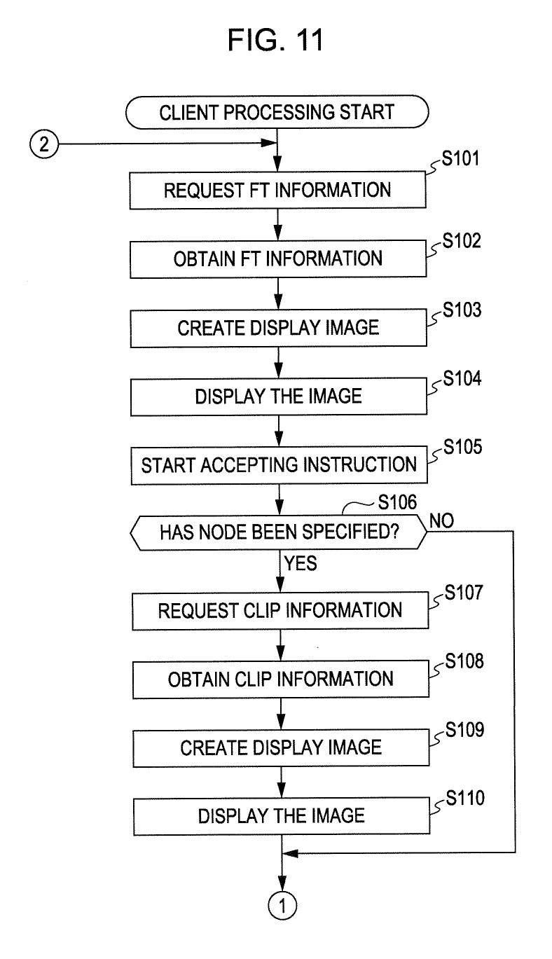

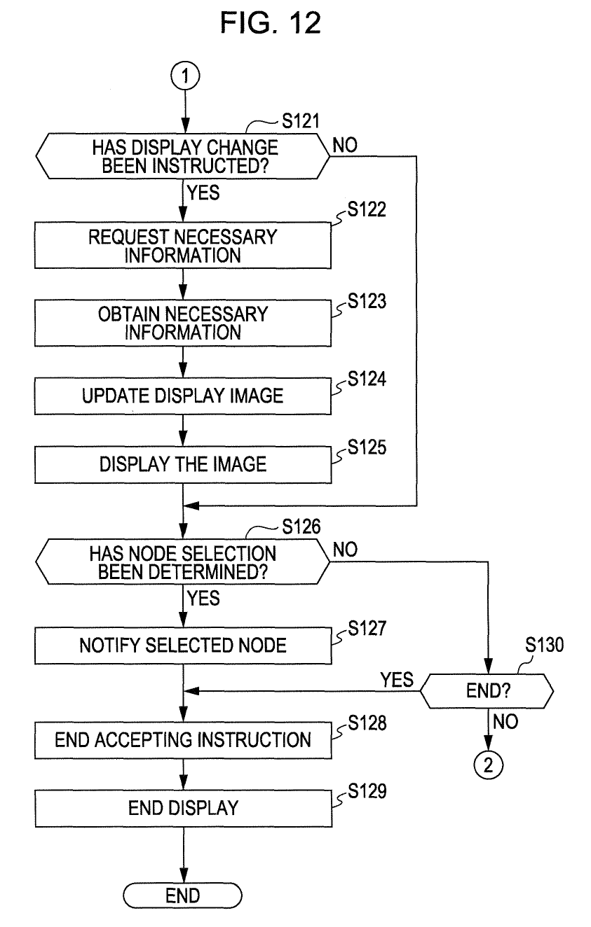

A description will be given of an example of the client processing flow for accepting a user instruction, which is executed in the remote client 103, with reference to flowcharts in FIGS. 11 and 12.

When the client processing is started, in step S101, the instruction providing section 422 requests FT information, which is family-tree (FT) information from the multi-format transcoder 101. In step S102, the information acquisition section 423 obtains the FT information supplied in response to the request.

In step S103, the image generation section 424 creates a display image (for example, the GUI image for FT 430 in FIG. 8) using the FT information. In step S104, the display control section 425 displays the display image on the monitor of the output section 212. In step S105, the input accepting section 421 controls the input section 211 to start accepting the user instruction.

In step S106, the input accepting section 421 determines whether a node of a family tree (FT) displayed in the display image has been specified or not. If determined that the node is specified, the processing proceeds to step S107.

In step S107, the instruction providing section 422 requests clip information of the clip corresponding to the node specified in step S106 from the multi-format transcoder 101. In step S108, the information acquisition section 423 obtains clip information supplied as a response to the request.

In step S109, the image generation section 424 creates a display image (for example, the GUI image for FT 430 in FIG. 8) using the clip information. In step S110, the display control section 425 displays the display image on the monitor of the output section 212.

When the processing of step S110 ends, the processing proceeds to step S121 in FIG. 12. Also, in step S106 in FIG. 11, if determined that a node has not been specified, the processing proceeds to step S121 in FIG. 12.

In step S121 in FIG. 12, the input accepting section 421 determines whether a display change has been instructed on the display image currently being displayed or not. If determined that an instruction to change display of the image, for example, cursor movement, GUI-button pressing, selection or release of an object, or starting or ending a new window, etc., has been given, the processing proceeds to step S122.

In step S122, the instruction providing section 422 requests necessary information for the instructed display change from the multi-format transcoder 101. In step S123, the information acquisition section 423 obtains the information supplied as a response to the request.

In step S124, the image generation section 424 updates the display image (for example, the GUI image for FT 430 in FIG. 8) with that information. In step S125, the display control section 425 displays the display image after the update on the monitor of the output section 212.

When the processing of step S125 ends, the processing proceeds to step S126. Also, in step S121, if determined that a display change has not been instructed, the processing proceeds to step S126.

In step S126, the input accepting section 421 determines whether node selection has been determined or not. If determined that node selection has been determined by, for example, the user pressing of the OK button 433, etc., the processing proceeds to step S127.

In step S127, the instruction providing section 422 notifies the multi-format transcoder 101 of the selected node (clip). In step S128, the input accepting section 421 terminates accepting an instruction. In step S129, the display control section 425 ends the display of the display image. When the processing in step S129 ends, the client processing ends.

Also, in step S126, if determined that node selection has not been determined, the processing proceeds to step S130. In step S130, the input accepting section 421 determines whether to end the client processing or not. For example, if the user has input an instruction to end displaying the display image, etc., and the client processing is determined to be terminated, the processing returns to step S128, and the subsequent processing is repeated.

Also, in step S130, if determined not to terminate the client processing, the processing returns to step S101 in FIG. 11, and the subsequent processing is repeated.

By performing the client processing as described above, the user is allowed to easily grasp features of the clip generated by format transcoding using the GUI image for FT shown in FIG. 8, for example. Thereby, the user is allowed to easily operate the operation of the multi-format transcoder 101. That is to say, it is possible for the remote client 103 to improve the operationality of the multi-format transcoder 101.

Genealogical Display

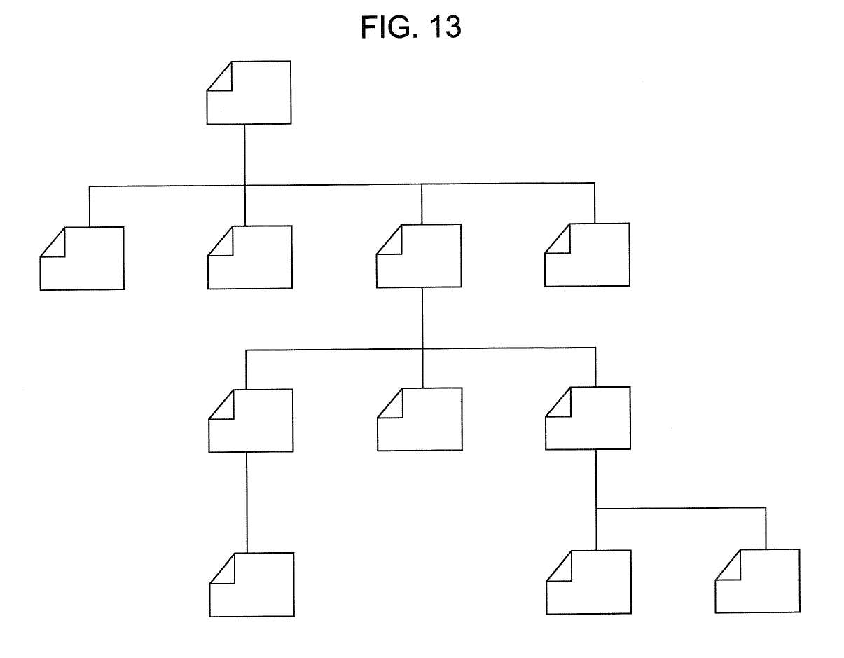

In this regard, a method of expressing a family tree (FT) is any one of methods. For example, as shown in FIG. 13, a genealogical family tree (FT) may be displayed. That is to say, in this case, the image generation section 424 generates a genealogical family tree.

In the case of a genealogical family tree shown in FIG. 13, in the same manner as the case of the tree-structured family tree described with reference to FIG. 8, a relationship between clips before and after transcoding (parent-child relationship) is shown by a line (or an arrow). However, in the case of a genealogical structure, a transcoding generation is shown by a clip position in up and down directions.

That is to say, a genealogical family tree and a tree-structured family tree are basically the same except that the layouts thereof are different. Accordingly, the information that can be expressed and the functions that can be performed are also the same. For example, the expression of the image size and the quality of a clip, copy operation of a family tree, etc., are also the same.

2D-Graphical Display

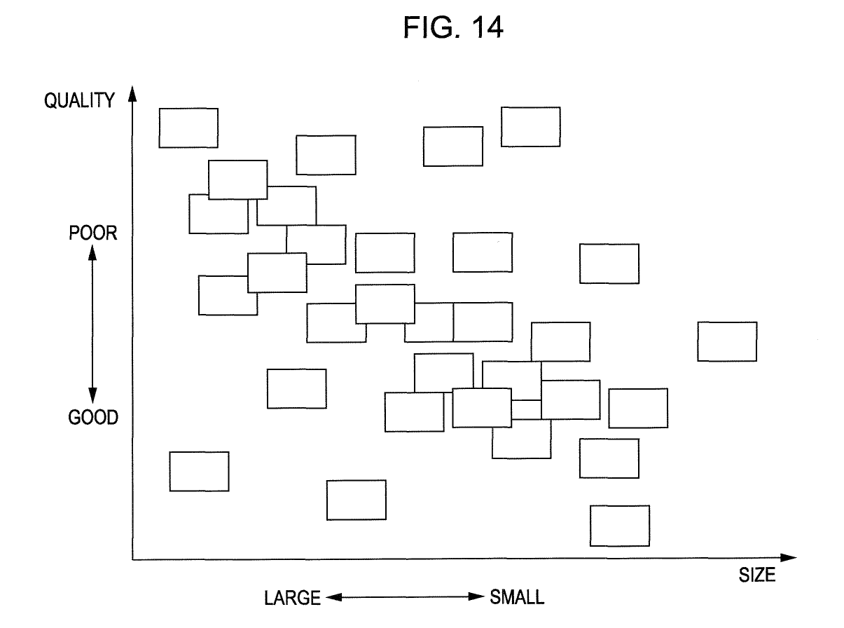

Also, a family tree (FT) can be expressed by a two-dimensional graph (expressed by a 2D-graphical family tree), for example, as shown in FIG. 14. That is to say, in this case, the image generation section 424 generates a 2D-graphical family tree.

In FIG. 14, each rectangle denotes a clip (node). In the case of the example in FIG. 14, the horizontal axis shows image size (resolution), and the vertical axis shows quality (a bit rate, a frame rate, etc.). That is to say, parameters that are different with each other are assigned to individual axes of the graph, respectively. Each clip on the graph indicates an image size and a quality (a plurality of features of a clip) by the position of the clip.

For example, the more at the left side a clip is positioned in the figure, the larger the image size of the clip (higher resolution) is, and the lower a clip is positioned in the figure, the higher the quality of the clip is (higher bit rate or frame rate).

In this regard, relationships between clips before and after transcoding (parent-child relationship) are expressed by ties between the individual clips using lines or arrows. However, if all the ties are displayed once, it might become too complicated to see.

Thus, the ties may be normally non-displayed. Only for a node specified by the user with a cursor, etc., the parent-child relationship thereof may be displayed.

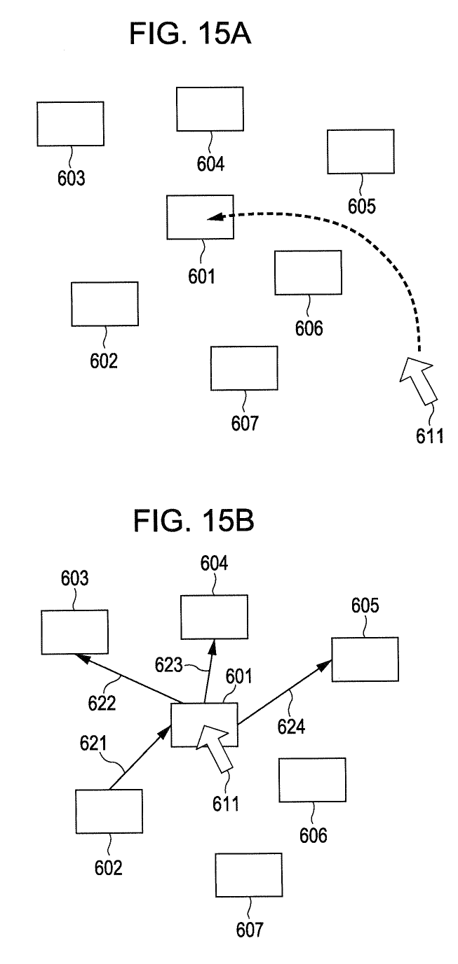

For example, normally, as shown in FIG. 15A, individual clips (a clip 601 to a clip 606) are displayed so as not to be tied with each other by a line or an arrow. For example, if the user places a cursor 611 on the clip 601, as shown in FIG. 15B, only the parent clip (transcoding source clip) of the clip 601, and the child clips (clips generated from the clip 601) are displayed with ties by a line or an arrow between the clips.

In the case of FIG. 15B, the clips are tied with arrows, and a direction of an arrow denotes a parent-child relationship (whether a parent or a child). That is to say, the clip 602 which is shown to be tied to the clip 601 by an arrow 621 facing toward the clip 601 is the parent clip of clip 601. Also, the clip 603 which is shown to be tied by an arrow 622 facing away from the clip 601, the clip 604 which is shown to be tied by an arrow 623 facing away from the clip 601, and the clip 605 which is shown to be tied by an arrow 624 facing away from the clip 601 are individually child clips of the clip 601.

In this manner, for only a necessary part on which the user places a cursor, parent-child relationships are displayed so that a family tree can be displayed to be easily seen by the user. In this regard, in the example in FIG. 15, a description has been given such that a parent clip and child clips of the user-specified clip are displayed. However, the present invention is not limited to this. Only the parent clip of the user-specified clip may be displayed, or only the child clips of the user-specified clip may be displayed.

In this regard, each node of a 2D-graphical family tree indicates an image size and a quality by the position of the clip.

Accordingly, a distance between clips indicates a similarity of both of the clip data. That is to say, the shorter the distance of clips is, the more similar the formats of the clips are. For example, in the case where a deleted file of a certain clip is restored from another clip by transcoding, if a clip having a long distance is transcoded for restoration, the load of the transcoding might increase. Except that transcoding aptitude described later is good and there is a special condition, a clip having a shorter distance (more similar clip) can be transcoded for restoration with lesser load.

Also, a positional relationship (direction) between both of the clips indicates aptitude of the transcoding. In the case of FIG. 14, the more at the lower left a clip is positioned, the better the quality of an image is. Accordingly, when a file of a certain clip is to be restored, it is possible to obtain a better restoration result (lesser deterioration of image quality) in the case of restoring the file from a clip positioned more at the lower left of that clip than in the case of restoring the file from a clip positioned more at the upper right of that clip. In this manner, the aptitude of transcoding is indicated by a positional relationship (direction) between both of the clips.

Thereby, at the time of restoring a file, the user is allowed to easily grasp a best-suited clip for carrying out transcoding.

2D-Graphical Application 1

In this regard, in a 2D-graphical family tree, parameters in the vertical axis and the horizontal axis are specified in any way. For example, the horizontal axis may show transcoding generation, and the vertical axis may show quality. Alternatively, the horizontal axis may show transcoding generation, and the vertical axis may show size. The parameters for the vertical axis and the horizontal axis may be exchanged as a matter of course.

Also, the size of each node may denote the image size (resolution) of each clip, and the color or the density of each node may denote the quality (for example, a bit rate or a frame rate) of an image of each clip.

Further, a method of displaying a node (for example, color, a density, a shape, or a size, etc.) of a clip whose file has been deleted may become special (for example, displayed by a dotted line).

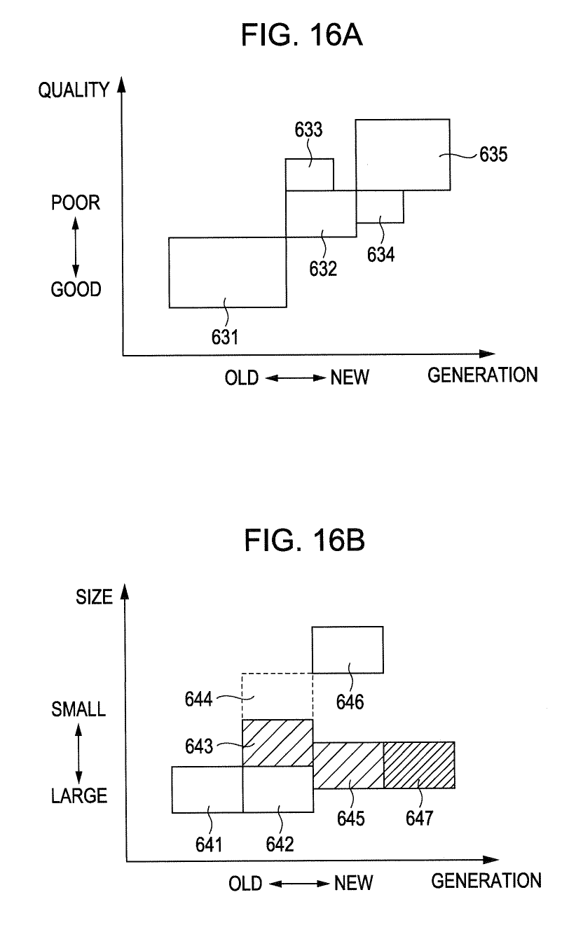

FIG. 16A illustrates an example of a 2D-graphical family tree showing the image size (resolution) of each clip by the size of each node with transcoding generation as the horizontal axis, and quality as the vertical axis.

In the 2D-graph in FIG. 16A, among a clip 631 to a clip 635, the more at the left side a clip is, the older the generation is (in an upper layer in the transcoding system), and the more at the right side a clip is, the newer the generation is (in a lower layer in the transcoding system). Also, at the lower side a clip is, the higher the quality of the clip is, and at the higher side a clip is, the lower the quality of the clip is. Further, the larger the rectangle of a clip is, the larger the image size is. And the smaller the rectangle of a clip is, the smaller the image size of the clip is.

FIG. 16B illustrates an example of a 2D-graphical family tree showing the quality of each clip and whether there is a file by the display of each node with transcoding generation as the horizontal axis, and image size as the vertical axis.

In the 2D-graph in FIG. 16B, among a clip 641 to a clip 647, the more at the left side a clip is, the older the generation is (in an upper layer in the transcoding system), and the more at the right side a clip is, the newer the generation is (in a lower layer in the transcoding system). Also, at the lower side a clip is, the smaller the image size is, and at the higher side a clip is, the larger the image size of the clip is. Further, the higher the density of shaded pattern is, the lower the image quality is. Also, the clip 644 displayed by a dotted line denotes a clip whose file has been deleted.

As described above, in the case of a 2D-graphical family tree, the user is allowed to intuitively (easily) grasp various kinds of information.

In this regard, a thumbnail image of an image included in a clip may be used as each node of a family tree. In that case, the user can easily grasp the contents of a content of each clip by referring to a family tree (FT).

2D-Graphical Application 2

In this regard, when the multi-format transcoder 101 performs transcoding, the larger the amount of data of a clip is, the heavier the load of the transcoding becomes. For example, the larger the image size of a clip to be transcoded is, or the higher the bit rate or the frame rate is, the heavier the load of the transcoding becomes.

If the transcoding load increases, the capacity of hardware necessary for the transcoding might increase. Also, the processing time might increase. In this manner, the cost necessary for the transcoding might increase.

In particular, as described later, if the multi-format transcoder 101 can execute a plurality of tasks in parallel at the same time, the cost of one piece of transcoding changes by the amount of execution of the task, namely, so-called “task congestion”.

In reality, the cost that is allowed for the transcoding has a limitation. Accordingly, when transcoding setting is carried out (for example, when a transcoding desirably source clip is selected), it is thought that the user takes the cost necessary for the transcoding into consideration.

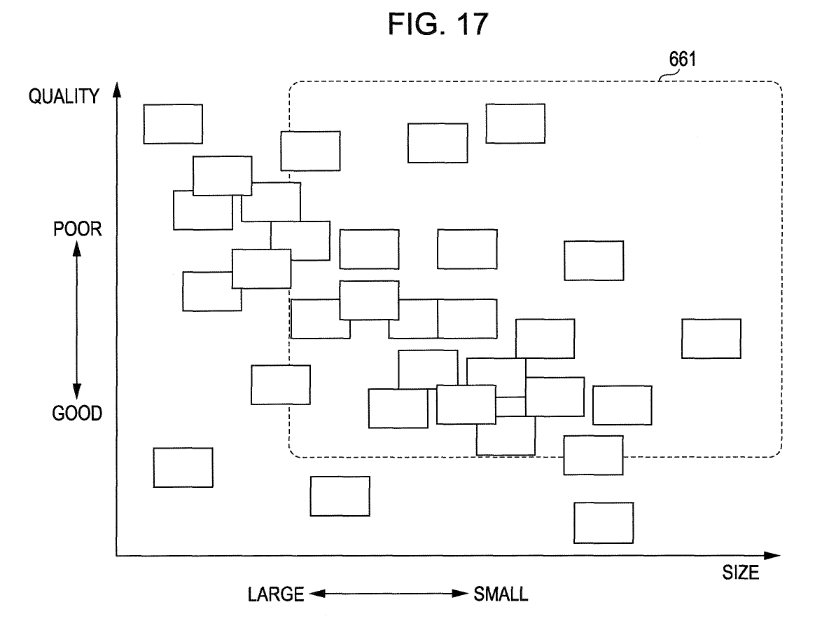

Thus, for example, as shown in FIG. 17, in a 2D-graphical family tree, a permissible range in cost may be shown by as a dotted line 661. For example, in the case of the example in FIG. 17, the more at lower left a clip is positioned, the heavier the load of transcoding becomes. On the other hand, a permissible range in the case of considering cost on the basis of the available capacity and assumed processing time of the multi-format transcoder 101 are indicated as the dotted line 661. That is to say, if transcoding is carried out from a clip outside the range indicated by the dotted line 661, the cost might goes out of the permissible range.

By doing like this, the user is allowed to easily carry out the setting in consideration of the cost of transcoding.

3D-Graphical Display

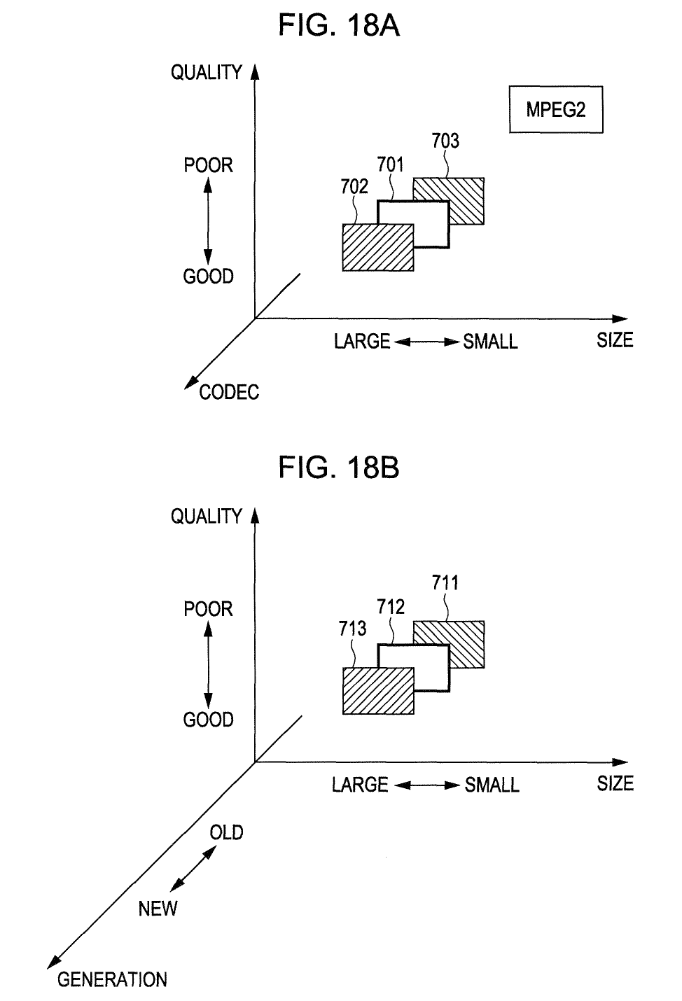

In this regard, in the case of a graphical family tree, any number of dimensions may be specified. For example, as shown in FIG. 18, a three-dimensional tree (3D-graphical family tree) may be used. In this case, the image generation section 424 generates a 3D-graphical family tree.

In the case of FIG. 18A, the horizontal axis shows image size, the vertical axis shows quality, and the back-and-forth direction axis shows type of codec. In the case of FIG. 18A, a clip 701 is the node of the codec currently selected. In order to allow easy determination, the codec name, such as “MPEG2”, is also displayed. A clip 702 and a clip 703 are coded by the other kinds of codec.

In the case of FIG. 18B, the horizontal axis shows image size, the vertical axis shows quality, and the back-and-forth direction axis shows transcoding generation. In the case of FIG. 18B, a clip 711 is an older generation, and a clip 713 is a newer generation. A clip 712 is the currently selected generation.

In the case of 3D-graphical family tree, on the back-and-forth direction axis, only a part of clips may be displayed. For example, in the case of FIG. 18A, if clips of all kinds of codec are displayed all at once, many clips are overlapped so that the clips might be different to see. Thus, for example, as shown in FIG. 18A, only a clip (clip 701) of a user-selected codec, and clips (a clip 702 and a clip 703) of the codec assigned before and after that may be displayed.

This is the same as in the case of FIG. 18B, only a clip (clip 712) of the user-selected generation, and clips (a clip 711 and a clip 713) of the generation of before and after that may be displayed.

In these cases, if the user changes a codec or a generation, the clips to be displayed will be changed accordingly.

Also, any parameters may be assigned to individual axes. Also, except that the number of axes is different, a 3D-graphical family tree is basically the same as the case of a 2D-graphical family tree, so that the description for the 2D-graphical family tree can also be applied to a 3D-graphical family tree.

Of course, a graph may be of four dimensions or more.

Management of a Plurality of Tasks

The multi-format transcoder 101 processes each processing, such as transcoding, etc., as a task. The multi-format transcoder 101 can manage execution of the tasks, and can also execute a plurality of tasks in parallel at the same time.

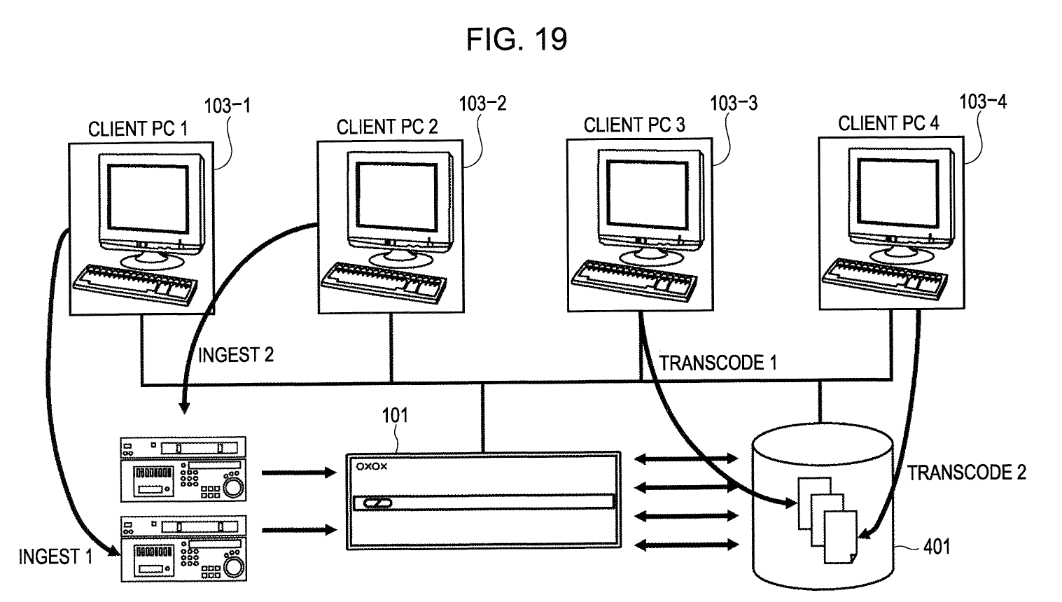

For example, as shown in FIG. 19, it is possible to accept requests from a plurality of remote clients 103 in parallel, and to schedule suitably and to perform various kinds of processing, such as ingest processing, transcoding, etc., in parallel. Thereby, it is possible to achieve a transcoding system 100 which executes processing efficiently.

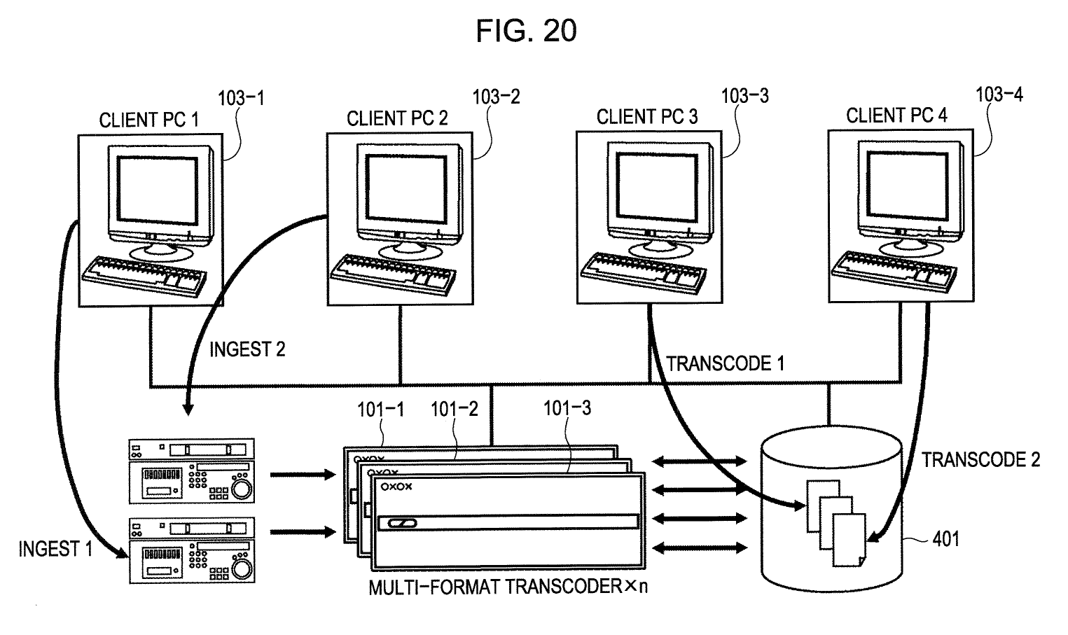

In this regard, any configuration of the transcoding system 100 is used. For example, as shown in FIG. 20, n units of the multi-format transcoders 101 may operate in cooperation with each other, and may allowed to distributedly process requests from a plurality of remote clients.

Thereby, it is possible to reduce the load of each of the multi-format transcoders 101, and thus it is possible to process a larger number of tasks at a high speed.

Software

The above-described series of processing can be executed by hardware or can be executed by software. If the above-described series of processing is performed by software, the programs constituting the software are installed from a network or a recording medium.

This recording medium includes not only a removable medium 221 or a removable medium 321, which stores the programs to be distributed to a user separately from the apparatus main unit as shown in FIGS. 4 and 5, for example, including a magnetic disk (including a flexible disk), an optical disc (a CD-ROM (Compact Disc-Read Only Memory)), a DVD (Digital Versatile Disc), a magneto-optical disc (including a MD (Mini Disc)), or a semiconductor memory, etc., but also includes a ROM 202 or a ROM 302, a hard disk included in a storage section 213 or a storage section 313, whish stores the program in a state of being incorporated in the apparatus main unit in advance, etc.

In this regard, the programs executed by the computer may be programs that are processed in time series in accordance with the described sequence in this specification. Alternatively, the programs may be the programs to be executed in parallel or at necessary timing, such as at the time of being called, or the like.

Also, in this specification, each processing step described by the program recorded in a recording medium is not necessarily processed in time series in accordance with the described sequence, but also includes processing to be performed in parallel or individually.

Also, in this specification, a system represents an entire apparatus including a plurality of devices (apparatuses).

Also, in the above, a component described as one apparatus (or processing section) may be divided and configured as a plurality of apparatuses (or processing sections). On the contrary, components described as a plurality of apparatuses (or processing sections) may be put together into one apparatus (or processing section). Also, a component other than described above may be added to the component of individual apparatus (or individual processing section). Further, if the configuration and the operation of the overall system are substantially the same, a part of a component of a certain apparatus (or processing section) may be included in a component of another apparatus (or another processing section).

The present application contains subject matter related to that disclosed in Japanese Priority Patent Application JP 2009-230943 filed in the Japan Patent Office on Oct. 2, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
on the basis of management information of a transcoding system of transcoding processing transcoding a format of a clip, an image generation means for generating a family tree being an image representing the clip by a node and representing a relationship between the clips on the transcoding processing by a link; and
a display control means for displaying the family tree generated by the image generation means on a display screen.

2. The information processing apparatus according to claim 1,
wherein the image generation means generates the family tree having a tree structure, representing the node by a predetermined figure, representing the link by a line or an arrow, and representing a generation of the transcoding of the clip by a position of the node in a right-and-left direction, and
the display control means displays the family tree having the tree structure, generated by the image generation means.

3. The information processing apparatus according to claim 2,
wherein the image generation means generates the family tree having the tree structure such that whether there is a file of each clip or not is indicated by a method of displaying the node.

4. The information processing apparatus according to claim 2,
wherein the image generation means generates the family tree having the tree structure such that an image size of each clip is indicated by a size of the node.

5. The information processing apparatus according to claim 2,
wherein the image generation means generates the tree-structured family tree such that a bit rate or a frame rate of each clip is indicated by color or a density of the node.

6. The information processing apparatus according to claim 2,
wherein the image generation means copies a configuration of the family tree having the tree structure under a desired clip to another clip in accordance with predetermined operation input by a user.

7. The information processing apparatus according to claim 1,
wherein the image generation means generates the family tree having a genealogical structure, representing the node by a predetermined figure, representing the link by a line or an arrow, and representing a generation of the transcoding of the clip by a position of the node in an up-and-down direction; and
the display control means displays the family tree having the genealogical structure, generated by the image generation means.

8. The information processing apparatus according to claim 7,
wherein the image generation means generates the family tree having the genealogical structure such that whether there is a file of each clip or not is indicated by a method of displaying the node.

9. The information processing apparatus according to claim 7,
wherein the image generation means generates the family tree having the genealogical structure such that an image size of each clip is indicated by a size of the node.

10. The information processing apparatus according to claim 7,
wherein the image generation means generates the family tree having the genealogical structure such that a bit rate or a frame rate of each clip is indicated by color or density of the node.

11. The information processing apparatus according to claim 7,
wherein the image generation means copies the family tree having the genealogical structure under a desired clip to another clip in accordance with predetermined operation input by a user.

12. The information processing apparatus according to claim 1,
wherein the image generation means generates the graphical family tree representing the node by a predetermined figure, representing the link by a line or an arrow, and representing a feature of the clip by a position of the node on the graph; and
the display control means displays the graphical family tree generated by the image generation means.

13. The information processing apparatus according to claim 12,
wherein the image generation means assigns different parameters with each other to individual axes of the graph.

14. The information processing apparatus according to claim 12,
wherein the graph is a two-dimensional graph.

15. The information processing apparatus according to claim 12,
wherein the graph is a three-dimensional graph.

16. The information processing apparatus according to claim 1, further comprising an instruction accepting means for accepting a user's instruction input on the basis of the family tree displayed on the display screen.

17. A method of processing information, comprising the steps of:
on the basis of management information of a transcoding system of transcoding processing transcoding a format of a clip, generating a family tree being an image representing the clip by a node and representing a relationship between the clips on the transcoding processing by a link; and
displaying the generated family tree on a display screen.

18. An information processing apparatus comprising:
on the basis of management information of a transcoding system of transcoding processing transcoding a format of a clip, an image generation section generating a family tree being an image representing the clip by a node and representing a relationship between the clips on the transcoding processing by a link; and
a display control section displaying the family tree generated by the image generation means on a display screen.
